(19) United States
(12) Patent Application Publication
(10) Pub. No.: US 2017/0189915 A1
(43) Pub. Date: Jul. 6, 2017

(54) SEPARATOR

(71) Applicant: GEA MECHANICAL EQUIPMENT GMBH, Oelde (DE)

(72) Inventors: Wilfried MACKEL, Lippetal-Herzfeld (DE); Andreas PENKL, Lippetal (DE); Thomas BATHELT, Oelde (DE); Kathrin QUITER, Drensteinfurt (DE); Marie-Theres SEDLER, Wadersloh (DE)

(21) Appl. No.: 15/313,279

(22) PCT Filed: May 26, 2015
(86) PCT No.: PCT/EP2015/061599

§ 371 Date: Nov. 22, 2016

(30) Foreign Application Priority Data
May 28, 2014 (DE) 10 2014 107 604.4

(51) Int. Cl. B04B 1/08; B04B 11/02; B04B 7/14

(52) U.S. Cl. CPC B04B 1/08; B04B 7/14; B04B 11/02

(57) ABSTRACT

A separator for the treatment of a flowable product by centrifugation has a rotatable drum delimiting a centrifuging space. The separator also includes, arranged in the drum, an agent for clarification of a product to be treated in the centrifugal field. The drum includes an outer support and an inner drum arranged in the outer support, and in the agent for the clarification of the product to be processed in the centrifugal field is arranged in the inner drum.

### BACKGROUND AND SUMMARY OF THE INVENTION

Exemplary embodiments of the invention relate to a separator.

Centrifugal separators for realizing continuous operation have long been known, for example in an embodiment as nozzle separators from Japanese patent document JP 62-117649 A. In addition to nozzle separators, separators with solids discharge openings are known, which are assigned a hydraulically actuable piston slide by way of which the solids discharge openings can be closed off and opened up. A separator without solids discharge, in an embodiment as a divider, is presented in US patent document U.S. Pat. No. 2,017,734. A separator with screwed-together, solid drum lower and drum upper parts is also presented in US patent document U.S. Pat. No. 2,286,354.

PCT International patent document WO 2014/000829 A1 further discloses a generic separator for the separation of a flowable product into different phases or for the clarification of a product, which separator has a rotatable drum with a drum lower part and a drum upper part and has a means for clarification arranged in the drum, wherein one, several or all of the following elements is or are composed of plastic or of a plastics composite material: the drum lower part, the drum upper part, the means for clarification. In this way, it is possible for a part of the drum, or preferably even the entire drum—preferably together with the inflow and outflow system or regions—to be designed for single use, which is of interest and advantageous for processing pharmaceutical products, such as fermentation broths or the like, because, after the operation for the processing of a corresponding product batch in preferably continuous operation during the processing of the product batch, no cleaning of the drum has to be performed because it is possible for the drum as a whole to be exchanged. From a hygienic aspect in particular, the separator is therefore highly advantageous.

Exemplary embodiments of the present invention are directed to a further improvement in the running characteristics and also the handleability of the generic design.

According to an aspect of the present invention the drum has an outer support device and a drum—referred to as inner drum—arranged within the support device. Furthermore, a means for clarification (or for optimizing the clarification action) of the product to be processed in the centrifugal area is arranged in the inner drum.

In this way, the running characteristics of the rotating system, in particular of the drum, are considerably improved in a simple manner, because the outer support device stabilizes the system. Since the support device is situated radially at the outside in relation to the drum wall that delimits the drum interior chamber, the actual drum that delimits the centrifuging chamber will hereinafter be referred to as “inner drum”.

In one variant, the outer support device is in the form of an outer ring that surrounds the inner drum axially in sections. Such a ring, in the manner of a “bandage”, stabilizes the structure at the outer circumference. The at least one stabilizing ring (or the multiple rings) is/are preferably composed of a metal, though may also be manufactured from a plastic or from a plastics composite material. It is also conceivable for a contour, for example a ring-shaped pocket that is open axially in one direction, to be provided on the outer circumference of the inner drum, into which pocket the stabilizing ring is inserted.

Furthermore, in a preferred refinement, it is advantageous if the outer support device is in the form of a circumferentially closed outer ring surrounding the inner drum axially in sections. It is, however, also conceivable for the outer support device to be in the form of a grate-like outer ring surrounding the inner drum in a particular axial section.

In another variant, the outer support device is in the form of an outer drum surrounding the inner drum completely or in sections. In particular, in this way, the running characteristics of the rotating system, in particular of the drum, are considerably improved in a simple manner because the outer drum dynamically and mechanically stabilizes the system. It is possible for both bending of the rotating system in a radial direction with respect to the axis of rotation D, and also the tendency for imbalances to arise, to be considerably reduced. Both the inner drum and the support structure may—but need not—be of relatively thin-walled design. In particular, the inner drum that is preferably to be exchanged after the processing of a product batch can hereby be manufactured in a very material-saving manner.

It nevertheless remains possible to utilize the advantages of the materials “plastic” or “plastics composite material” because it remains possible for a part of the drum—the inner drum and preferably the constituent parts thereof—in particular together with the inflow and outflow systems or regions—to be designed for single use, such that, after the operation for the processing of a corresponding product batch, in preferably continuous and sanitary operation during the processing of the product batch, no cleaning of the drum is necessary, with the drum as a whole being exchanged rather than cleaned. The exchange is particularly simple because the outer drum, which is preferably reused, does not require major cleaning because it preferably does not come into contact at all with the product to be processed. The outer drum therefore does not need to be cleaned and/or disinfected, or needs to be only relatively quickly cleaned and/or disinfected, upon every exchange of the inner drum.

The exchange of the inner drum and the mounting, dismounting and other handling thereof may also be performed easily because, due to the fact that a stable outer drum structure is provided into which the inner drum merely has to be inserted, it is possible for the drive connection to an electric motor to be provided only on the outer drum, such that, during an exchange, it is merely necessary for the inner drum to be removed from the outer drum and for another inner drum to be inserted into the outer drum again, without numerous complicated mounting steps, such as the production of a drive connection to the drive shaft, being necessary for this purpose.

Here, the outer drum may surround the inner drum completely. However, good stabilization of the rotating system is also realized even if the outer drum surrounds the inner drum axially only in sections, preferably over at any rate 50% of the axial length of the inner drum or more. In the latter case, it is advantageous if the inner drum protrudes axially out of the outer drum, which makes it easier for the inflow and outflow region of the inner drum to be clearly divided and spaced apart from the outer drum.

It is particularly advantageous if the inner drum and the outer drum are composed of different materials because this makes it possible for, in each case, the optimum materials to be selected for both of the elements outer drum and inner drum. The inner drum is preferably composed of an in turn preferably relatively thin-walled plastic or a plastics composite material, such that it can be easily disposed of, and the reusable outer drum is composed of metal, in particular of steel, such that its running characteristics can be optimized in a particularly effective manner.

A further advantage of this is that, with the use of a metallic outer drum and of an inner drum composed of plastic, the weight of the outer drum may greatly exceed that of the inner drum, such that the rotational characteristics are defined substantially by the outer drum. For this purpose, it is preferably the case that the weight of the rotating parts of the metallic outer drum is more than twice as great, in particular more than four times as great, as the weight of the rotating parts composed of plastic or as the weight of the empty inner drum. By way of the outer drum, it is also possible for the inner drum to be designed with particularly thin walls, because the outer drum stabilizes the inner drum.

In order that the inner drum can be inserted effectively and easily into the outer drum, it is advantageous if the outer drum has an outer drum lower part and an outer drum upper part that is detachable from the outer drum lower part. By contrast, substantially for manufacturing reasons, it is advantageous if the inner drum has an inner drum lower part and an inner drum upper part that can be or is preassembled with the inner drum lower part. This is because it is necessary for various elements such as the means for clarification, an inflow pipe and the like to be positioned in the inner drum during the production process, which is simplified by way of the division into upper part and lower part.

The mounting of the inner drum in the outer drum is particularly simple if the outer drum upper part is formed in the manner of a ring screwed to the outer drum lower part and which is formed so as to be open in an axially upward direction, such that the inner drum upper part protrudes axially out of the outer drum upper part. The outer drum lower part and the outer drum upper part may also be connected in some other way. An advantageous variant is a connection by way of screw bolts. A bayonet is also conceivable as a connecting means. Finally, it is advantageous for the outer drum upper part and the outer drum lower part to be connected to one another, or fixed relative to one another, by way of a fastener ring. For this purpose, it is preferably the case that a lower edge of the outer drum upper part is inserted into the outer drum lower part, where the outer drum upper part can lie on a collar. Then, a ring with an external thread is screwed from above into an internal thread of the outer drum lower part, which automatically fixes the outer drum upper part on the outer drum lower part.

To realize a reliable rotation as far as possible without slippage between the inner drum and the outer drum, it is advantageous if the inner drum and the outer drum are connected rotationally conjointly to one another in non-positively locking and/or positively locking fashion.

For reasons of hygiene, it is furthermore advantageous if an inflow system and an outflow system of the drum are formed exclusively on the inner drum, such that the outer drum does not come into contact with the product to be processed during operation. The inflow system and the outflow system are preferably formed, in a sealed type of construction, on the inner drum.

In a further refinement, it is advantageous if the inflow system and the outflow system have a covering ring body formed as a part that does not rotate with the drum during operation and if the inflow system has an inflow pipe formed as an element that rotates with the drum. For this purpose, the covering ring body is preferably connected rotationally conjointly to a counter-bearing of the separator outside the drum.

In this way, the transfer of the product into the rotating system is realized already at the inlet of the inflow pipe, which simplifies the construction of the inner drum.

The discharge system is preferably formed without a centripetal pump. The phases to be discharged flow out of rotating ducts between pipe ends/sections into ring-shaped chambers in the non-rotating covering ring body, and from there into non-rotating discharge lines and downstream tanks or the like.

However, in a further variant, which is preferred due to the fact that it is of less complex design, it is also conceivable for the outflow system to be realized with the aid of one or more grippers composed of plastic, which grippers, in the manner of centripetal pumps, conduct the one or more phases separated in the centrifugal area out of the drum.

In a refinement which is, however, also to be regarded as a separate invention at least one or more of the pipe elements of the drum is/are axially displaceable in the ring body, and a device for the detachable fixing of the pipe element in an axial position in the ring body is provided. In this way, the structure is stabilized for transportation in a simple manner, and cannot become detached. The securing action is released for the first time at the installation site, in order that the elements can rotate relative to one another. The design is expedient in the case of an inner drum, or else in the case of a drum without inner drum, for example in the manner of PCT International patent document WO 2014/000829 A1.

It is also advantageous if the transport lock is utilized during the dismounting of the drum. For this purpose, the transport lock is reactivated after/during dismounting of the inner drum, in order that the inner drum can be more easily dismounted and disposed of. Here, line ends may be closed off again (for example by adhesive bonding or clamping or detent action).

Overall, for handling reasons, it is particularly advantageous if the inner drum, in particular the entire inner drum, preferably together with the inflow and outflow system, is configured as an exchangeable, preassembled module. The module is preferably entirely, or at any rate predominantly (that is to say in particular more than 70%, in particular more than 80% of the weight of the module), composed of plastic or of a plastics composite material. It is also conceivable for limited local reinforcements, composed for example of metal or plastic or of some other suitable material, to be provided in the region of the inner drum. In this respect, the inner drum also forms independent subject matter.

The inner drum itself is in the form of a circumferentially closed drum extending around the axis of rotation of the drum and preferably forming a self-supporting unit. The self-supporting unit is dimensionally stable such that, after being placed onto the outer drum lower part, the unit maintains its shape without an outer drum upper part being placed on (in a standstill state, that is to say when not set in rotation). This refinement consequently does not involve dimensionally stable pouches or the like. The inner drum is furthermore preferably not cohesively connected to the outer drum, that is to say does not involve a coating of the outer drum or the like.

The outer drum upper part should preferably have a central opening large enough so that it can be mounted from above over the covering ring body with its inflow and outflow connectors and hoses possibly attached thereto, which hoses merely have to be connected after the mounting process. In this way, the mounting of the inner drum can be realized particularly easily and quickly after the removal of the outer drum upper part.

The means for the clarification of a product to be processed from a phase containing more solids per unit volume than the other phase is preferably and advantageously in turn a partition disk assembly composed of conical partition disks composed of plastic, though may, for example, also be a unipartite clarification/separation insert composed of plastic in the manner of German patent document DE 10 2008 052 630 A1, or some other means for the clarification of a product of solid particles such as a rib body with radial ribs or the like. The separator drum is preferably utilized for further concentrating a product, that is to say, using the means for clarification, a phase which contains a greater solids fraction per unit volume but which is preferably still just flowable is separated from a phase that contains less solids. The expression “means for clarification” is thus to be interpreted relatively. It relates to this usage, too, wherein here, the means for clarification serves for further concentrating the product or obtaining a concentrated phase.

Altogether, it is also the case with the concept of the inner drum that some, and preferably even all, of those regions of the rotating system coming into contact with the product are composed of a plastic or of a plastics composite material, in particular the inner drum lower part and the inner drum upper part and the disk assembly. It is furthermore preferable, and advantageous with regard to a single use, if the inflow system and the outflow system are composed entirely or predominantly of plastic or of a plastics composite material.

It is advantageous for all or at any rate the majority of those parts of the inner drum that rotate during operation, and the parts of the inflow and outflow system, which do not rotate during operation, of the inner drum, where the parts come into contact with product, to be composed of plastic, and for only a relatively small number of parts, for example plastics injection molded parts, to be provided overall—aside from seals that may have to be provided. In addition or alternatively, it is possible for pipe sections to be formed as sleeves composed of metal, or it is possible for parts of the inner drum or in/on the inner drum, in particular pipe sections, to be reinforced by way of one or more sleeves composed of metal.

These are preferably the inner drum lower part, the inner drum upper part, the distributor, the separation means (preferably the disk insert for the separation of solids), a separation disk and the discharge means. In addition, sealing rings may also be provided. In this way, a functional centrifuge drum composed of plastic is realized composed of only very few constituent parts, which makes the production and mounting thereof particularly simple. It would also be possible for the elements of separating disk and inner drum upper part to be formed in one piece. In this case, the drum upper part would be provided directly with one or more ducts through which, as is the case at a separating disk or similarly thereto, one or more phases can flow from a region of relatively large diameter in the drum to the tip thereof to a point of discharge from the rotating system.

Here, it is furthermore particularly advantageous if the inner drum lower part and the inner drum upper part are non-detachably connected to one another at the initial assembly stage, in order to prevent attempts to disassemble them and possibly reuse them after insufficient cleaning. Instead, the inner drum is fully disposed of or recycled. A further advantage of this is that sterility is ensured. The design is preferably such that, before mounting and after dismounting, no air can enter into the inner drum from the outside.

With the concept of the inner drum, it is furthermore possible, as in PCT International patent document WO 2014/000829 A1, for a part of the drum, or preferably even the entire drum—preferably together with the inflow and outflow systems or regions—to be designed for single use, which is of interest and advantageous in particular with regard to the processing of pharmaceutical products such as fermentation broths or the like, because, after the operation for the processing of a corresponding product batch in preferably continuous operation during the processing of the product batch, no cleaning of the drum has to be performed, it rather being the case that the drum as a whole is exchanged. Hygiene problems associated with cleaning are hereby eliminated in a simple manner. Those parts coming into contact with the product may be entirely disposed of or recycled. Disposal is of interest in particular in the case of hazardous substances. It is in turn also conceivable, in the case of a process of clarification of a product, for primarily a concentration of a product to be processed to be performed, and for the inner drum, after the processing of a batch, to be melted down or for example dissolved in an acid or the like in order to obtain the heavy substance as a residue of the process. Through the use of preferably thin-walled plastics parts, it is furthermore possible for production costs to be kept relatively low.

Here, in turn, it is advantageous and particularly hygienic if the entire drum, in particular also the inflow system and the outflow system thereof, is formed in a sealed type of construction.

As plastic, use is preferably made of a recyclable plastic, in particular PE (polyethylene), PP (polypropylene) or TK-PEEK (in particular crystalline) polyether ether ketone. Also conceivable are inter alia (and this is not an exhaustive list) the materials PC (polycarbonate), MABS (methyl methacrylate acrylonitrile-butadiene-styrene), ABS (acrylonitrile-butadiene-styrene) and PSU (polysulfone).

It would be possible for the parts manufactured from plastic to be produced in an injection molding process and, if necessary, subjected to finish machining, for example provided with bores and the like, where necessary.

Screws and the like may also be composed of plastic, though may also be manufactured from some other material, in particular if they do not come into contact with the product during the processing.

A further particularly advantageous invention relates to an advantageous drum for a separator, provided as an inner drum, and the advantageous refinements thereof. Specifically the inner drum of the invention exhibits particularly high running smoothness and is thus highly suitable as an inner drum for an outer drum. Worthy of emphasis are the integrated means for clarification in the inner drum and also the advantageous positive-locking means, provided in one refinement, for the surprisingly secure and effective transmission of torque between inner drum and outer drum. This is because a configuration in which the inner drum is driven purely by way of a clamping action has proven to be less optimal owing to effects such as slippage and the like. The inner drum is highly suitable for single use, in particular having been pretreated by way of radiation such as gamma radiation.

### BRIEF DESCRIPTION OF THE DRAWING FIGURES

The invention will be described in more detail below on the basis of exemplary embodiments and with reference to the figures, in which:

FIGS. 1a-1f show, in 1a), a view of a separator according to the invention with a direct drive and with a housing and drum illustrated in section, in 1b), a more detailed and enlarged illustration of an outer circumferential region of a separator drum, in 1c) and 1d), alternative designs of the region from 1a), in 1e), a more detailed and enlarged illustration of an inflow and outflow region of the separator drum from FIG. 1a; and in 1f), an enlarged illustration of an outer circumferential region of a further separator drum;

FIG. 2 shows a section through an inflow region of a separator drum;

FIG. 3a-3c show, in 3a), a section through a further inflow region of a separator drum and, in 3b) and 3c), sections perpendicular to the view 3a), on the one hand in a transport position and on the other hand in a non-transport position;

FIG. 4 shows a section through an inflow region of a separator drum; and

FIGS. 5, 6, and 7 show sectional views of a partial region from FIG. 1a in alternative refinements.

### DETAILED DESCRIPTION

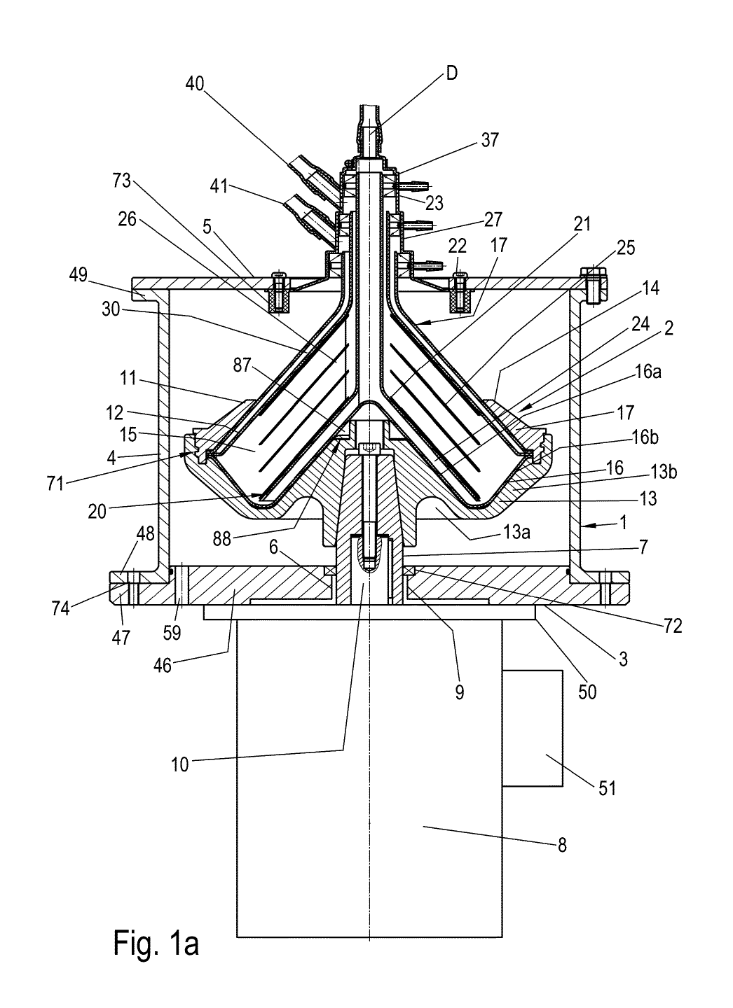

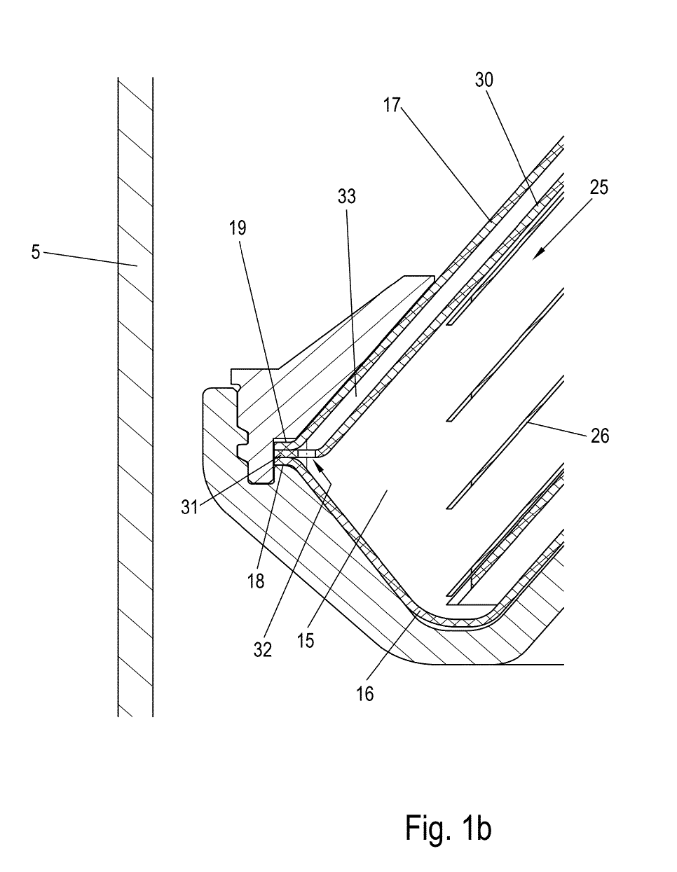

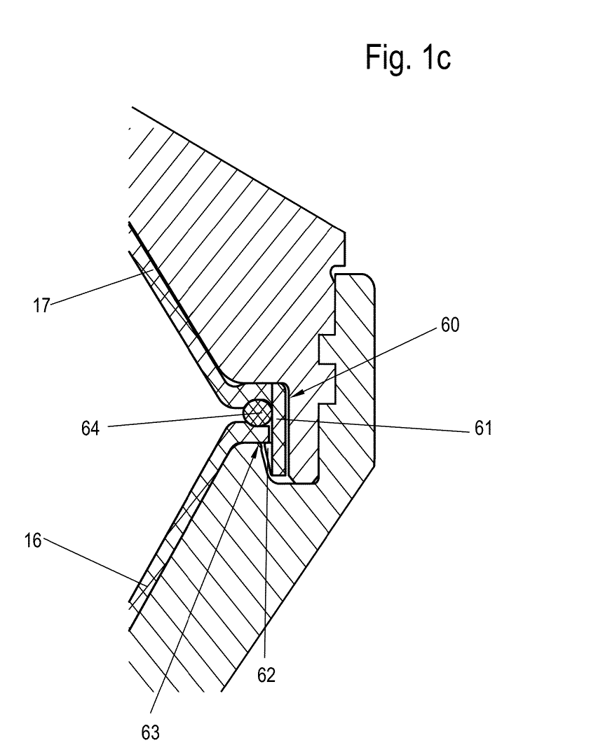

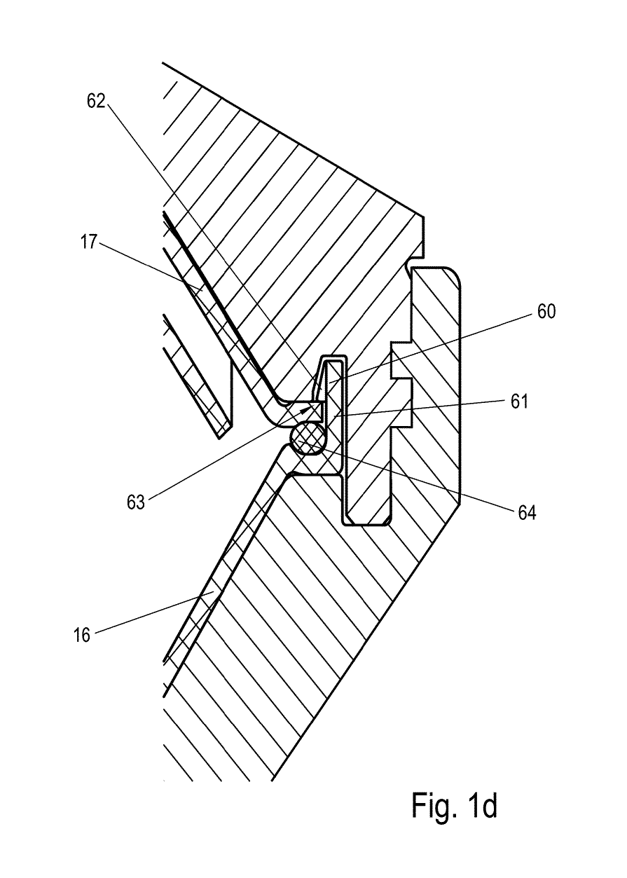

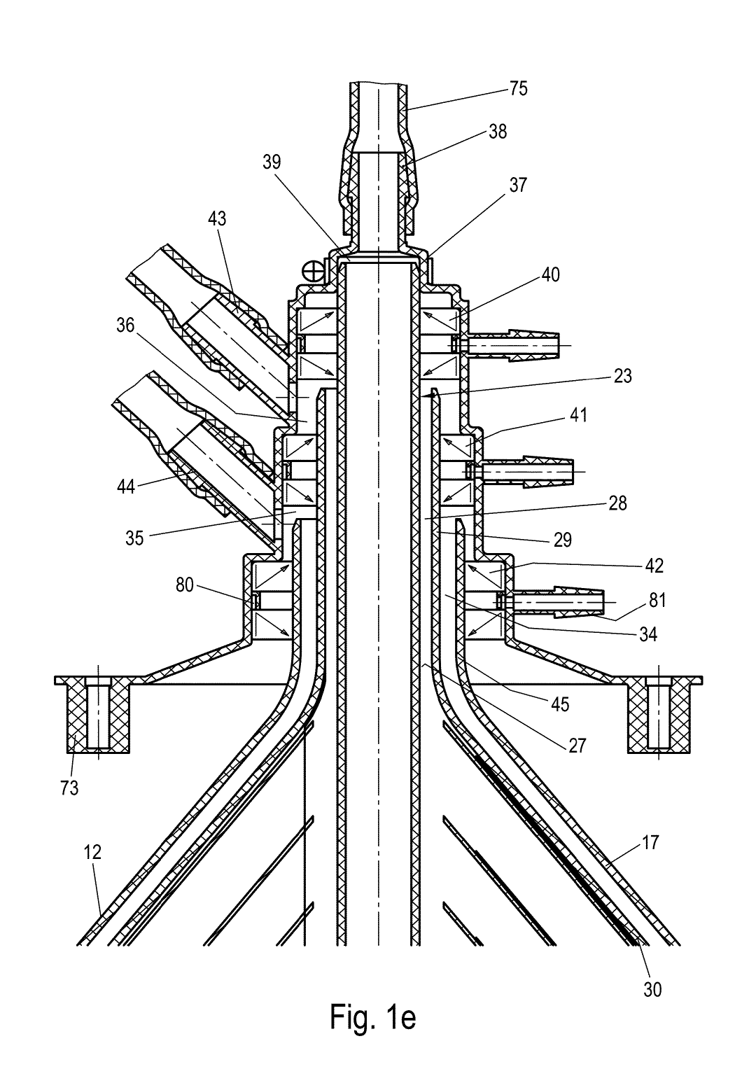

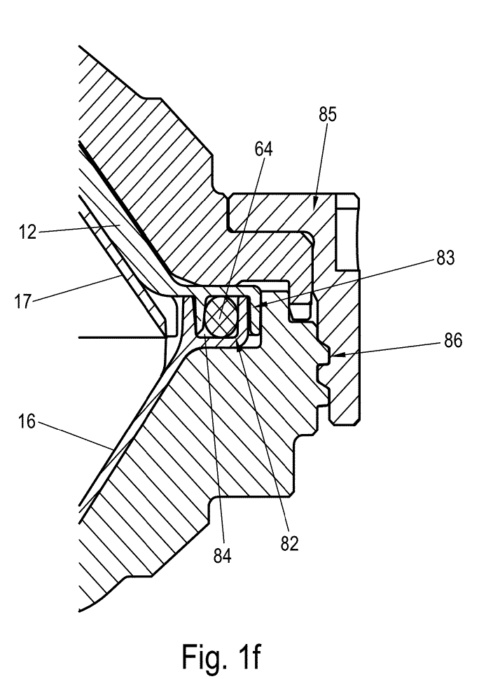

FIGS. 1a-1f show a section through the region of a housing 1 and of a drum 2 of a separator according to the invention, by means of which a liquid product can, in the centrifugal area, be separated into two phases. The drum 2 has a vertical axis of rotation D. Expressions such as “top” or “bottom” used hereafter relate to the orientation of elements of the separator in relation to the vertical axis of rotation.

The housing 1 has a lower base 3, a housing shell 4 and a top cover 5. The base 3 has, in turn, a leadthrough 6 through which a rotatable drive spindle 7 extends. A drive motor 8 is preferably arranged directly below the base 3. The drive motor 8 serves for driving the drive spindle 7. Alternative refinements are conceivable, for example one in which the drive spindle 7 is driven by a drive belt or the like, wherein then, the drive motor is arranged at some other location. What is preferable, however, is a direct drive in particular in the manner of FIG. 1a, in the case of which the drive shaft of the motor is arranged directly as a vertical elongation of the drive spindle 7. Here, a dedicated bearing arrangement of the spindle structure is preferably dispensed with, which makes it possible for the design to be realized easily and at relatively low cost. The design is simple and robust and is very well suited to the lightweight drum structure. The function of the bearing arrangement of the drum is performed in a simple manner by the electric motor or the rotor bearing arrangement thereof.

In turn, the drum 2 is mounted on the vertically upper end of the drive spindle 7 so as to be non-rotatable relative to the drive spindle 7, such that the drum can be set in rotation by the drive spindle 7 and the drive motor 8.

It would be possible for the drive spindle 7 to be mounted rotatably by way of one or more bearings in the housing 1, in this case in the base 3. It is, however, also possible for a bearing arrangement of this type to be omitted. Rather, a gap 9 is formed between the outer circumference of the drive spindle and the inner circumference of the leadthrough 6 of the base 3. In this way, it is possible for a bearing arrangement of a drive shaft 10 in the motor housing of the drive motor 8, to which drive shaft the drive spindle 7 is fixed or on which drive shaft the drive spindle is formed in some other way, to easily also be utilized for the bearing arrangement of the entire rotating system composed of drum 2 and drive spindle 7. It is thus also preferable for the drive spindle 7 to be coupled directly to the drive output shaft of the motor, and for the drive spindle 7 to have no additional rotary bearing—for example no neck journal bearing and no foot bearing—on its outer circumference. It is preferably also the case that no spring system is provided for resilient support in the region of the drive spindle. A seal 72 serves for sealing the gap 9. The seal 72 may, for example, be a slip ring seal or some other suitable seal in the ring-shaped gap 9 between the parts 3, 7, which rotate relative to one another.

Below, the construction of the drum 2 will be discussed in more detail, which deviates considerably from the construction of known designs.

This is because the drum 2 has an outer drum 11, which may also be in the form of an outer drum section, and an inner drum 12.

It is preferable that the outer drum section or the outer drum 11 and the inner drum 12 are composed of different materials. The outer drum 11 is preferably composed of metal, in particular of steel, and the inner drum 12 is preferably entirely or at least partially, in particular predominantly, composed of a plastic or a plastics composite material.

Here, the outer drum 11 serves as a type of holder into which the inner drum 12 is inserted. The holder surrounds the inner drum 12 over the full circumference, or encloses the inner drum, at least in sections in a vertical or axial direction. The outer drum 11 and the inner drum 12 are preferably rotationally conjointly connected to one another. This may be realized in particular by way of a positively locking and/or non-positively locking action between the outer drum 11 and the inner drum 12.

The outer drum 11 has an outer drum lower part 13 which may be, or in this case is, substantially formed without an inner drum, like the drum lower part of known separators. The outer drum lower part 13 is mounted rotationally conjointly on the drive spindle 7 and preferably has, at the inside, a singly or in this case preferably doubly conical inner shape, which leads to good rotational and separation behavior at the separator drum. The outer drum 11 furthermore preferably has an outer drum upper part 14. It is preferable that the outer drum lower part 13 and the outer drum upper part 14 have corresponding threads 71, in the region of which the outer drum lower part and outer drum upper part are directly screwed to one another. In this case, the thread of the outer drum lower part section is in the form of an internal thread of the drum lower part, and the thread of the outer drum the part 14 is formed as a corresponding external thread.

The outer drum upper part 14 is likewise of conical form. It is furthermore in the form of a ring which, at the bottom, is connected rotationally conjointly to the outer drum lower part 13 and which is open in an upward direction, such that the inner drum 12 protrudes vertically or axially upward out of the outer drum, in this case out of the outer drum upper part 14. It is preferable that the outer drum upper part 14 extends only into the conical section of the inner drum upper part 17, such that the latter still protrudes, by way of a part of its conical region (preferably by way of more than 20% of the vertical length of the region), vertically upwardly out of the outer drum upper part 14. It has been found that this already leads to very good rotational characteristics. The outer drum upper part can thus be reduced to a conical ring.

Since the outer drum lower part 13 and the outer drum upper part 14 are preferably composed of metal, in particular steel, and, preferably, at least the drum lower part is designed in the same way as that of a separator drum without inner drum 12, these can substantially offer the running smoothness and stability and safety of a known modern separator drum composed of metal. Since the outer drum 11 surrounds the inner drum 12 in sections or completely, the outer drum stabilizes the inner drum. In particular, the outer drum 11 advantageously contributes to an optimization of the running characteristics of the entire drum 2 during operation at high rotational speed. Furthermore, the wall thickness of the inner drum 12 may also be selected to be very much thinner than that of a plastics separator drum without outer drum 11, as proposed in PCT International patent document WO 2014/000829 A1.

By contrast, the inner drum 12 delimits, in an outward direction, the actual separation or centrifuging chamber 15 for the processing of a flowable product by centrifugation.

The inner drum 12 is, with regard to shaping, designed such that it bears preferably in substantially positively locking fashion directly against the inner circumference of the outer drum.

The inner drum 11 has an inner drum lower part 16 and an inner drum upper part 17. The inner drum lower part 16 and the inner drum upper part 17 are in each case of conical form, such that a doubly conical body is formed. The parts 16 and 17 are composed of plastic or of a plastics composite material and are connected to one another in liquid-tight fashion, in particular in the upper (inner drum lower part 16) and lower (inner drum upper part 17) flange regions 18, 19 (see FIG. 1b).

A cohesive connection is preferably provided between the inner drum lower part 16 and the inner drum upper part 17 and possibly further elements of the inner drum 12, which cohesive connection may, within the meaning of this document, be realized, for example, by way of fusion or else by way of adhesive bonding.

Other types of connection are also conceivable, for example a bayonet fastener between the elements to be connected, specifically inner drum lower part 16 and inner drum upper part 17. FIGS. 1c and 1d each illustrate different connection variants between the elements to be connected, specifically inner drum lower part 16 and inner drum upper part 17, in the case of which these are connected to one another by way of a detent connection.

For this purpose, one or more first and second detents 60, 63 is or are provided either on the inner drum upper part 17 (FIG. 1c) or on the inner drum lower part 16 (FIG. 1d), which detents are provided for interacting with a corresponding detent edge or contour on the other inner drum part. The first detent 60 may be formed as one or more webs 61, which are formed axially on the outer circumference of the inner drum upper part 17 and which extend axially in the direction of the inner drum lower part and which have a radially inwardly projecting detent contour 62 engaging under the inner drum lower part 16 at the outer circumferential edge—which thus forms the counterpart detent means. Alternatively, the webs 61 may be formed with a radially inwardly projecting detent contour 62 on the inner drum lower part 16 and engage over the inner drum upper part 17 at the outer circumferential edge—which thus forms the counterpart detent 63.

Other connection variants between the inner drum lower part 16 and the inner drum upper part 17 may also advantageously be realized, for example screw connections using plastics screws and nuts or the like (not illustrated here). A further expedient connection is one in which the inner drum lower part and the inner drum upper part are clamped together at the outer circumference by way of one or more clamps (not illustrated here). These types of connections between the inner drum parts 16, 17 are easy to handle, are inexpensive to realize and are nevertheless highly functionally reliable.

At least one preferably encircling sealing ring 64 may be arranged axially between flange regions 18, 19 between the inner drum lower part 16 and the inner drum upper part 17 in order to ensure the sealing action of the (plastics) inner drum (FIGS. 1c and 1f).

The sealing ring 64 may be a separately inserted sealing ring or may be designed as a sealing ring strip that is injection-molded onto one or both of the flange regions.

In FIG. 1f, the inner drum lower part 16 and the inner drum upper part 17 have, in each case in the region of their largest outer circumference, channels 82, 83 which are open upwardly (inner drum lower part 16) and downwardly (inner drum upper part 17) respectively and which are of U-shaped cross section and which, in the assembled state of the inner drum 12, engage into one another and form a ring-shaped chamber 84 which is circumferentially closed in cross-section. Here, the sealing ring 64 is arranged in the ring-shaped chamber 84. In the event of rotation, the sealing ring moves radially outward and expands, such that the ring-shaped chamber or the interior of the inner drum 12 is sealed off in an effective manner. Additionally, a locking means such as a detent may be formed between the inner drum lower part 16 and the inner drum upper part 17. The outer drum lower part 13 advantageously extends, in FIG. 1f, vertically upward to such an extent that it stabilizes the inner drum radially at the outside in the region of the channels 82, 83.

In FIG. 1f, it is furthermore the case that the inner drum upper part 17 is fixedly screwed by way of a stepped fastener ring 85 to the inner drum lower part, wherein corresponding threads 86 are formed between the fastener ring 85 and the inner drum lower part 17, and wherein the fastener ring 85 presses the inner drum upper part 17 against the inner drum lower part 16. In this way, too, a very good sealing action is assisted.

In this case lower section 20 of the inner drum lower part 16 is adjoined axially upwardly by a distributor, in particular distributor neck 21 (see FIG. 1a again), which is in the form of a separate part or which is integrally connected to the inner drum lower part, which distributor or distributor neck coaxially surrounds the axis of rotation D and forms a complete distributor for introducing the material for centrifuging into the inner drum interior chamber or centrifuging chamber 15 and for accelerating the material for centrifuging in a circumferential direction when the drum 2 rotates.

In the distributor neck 21 there is formed, in the upper region, for example a bore in the form of a blind hole, into which bore an inflow pipe 23 opens. The inflow pipe 23 may also be integrally formed directly on the distributor neck, or may be formed directly in one piece therewith in some other way. The inflow pipe 23 and the distributor neck 21 form an inflow system, which is preferably advantageously designed so as to be sealed off with respect to the surroundings. The inflow pipe 23 preferably protrudes axially upwardly out of the inner drum upper part 17 and rotates with the drum 2 during operation.

The distributor neck 21 opens at the lower end into one or more distributor ducts 24 that are formed obliquely with respect to the axis of rotation and which, in this case, open likewise obliquely into the centrifuging chamber 15 itself.

In the centrifuging chamber 15 there are arranged separation means or means for clarification, such as in particular a unipartite or preferably multi-part disk assembly 25 formed as a stack of axially spaced-apart partition disks 26 having a conical basic shape and which are preferably mounted in rotationally fixed fashion on the distributor neck 21. It would also be possible for the separation means for clarification to be of some other form, for example as rib bodies with radial or arcuate ribs. The partition disks 26 have identical or different radii.

The distributor neck or distributor 21 may also be formed in one piece with the means for clarification, if the means is in the form of a clarification insert composed of plastic with clarification chambers in the manner of German patent document DE 10 2008 052 630 A1. A product introduced into the inner drum interior chamber or centrifuging chamber 15 is, in the drum 2, separated into different, preferably two, product phases of different density.

For the discharge of the different product phases from the drum 2, use is made of an outflow system with two or more outflow regions.

Accordingly, a relatively light liquid phase flows radially inward and, there (see FIGS. 1a and 1 e), is conducted axially upward in a duct 27 on the outside of the distributor neck 21 into a ring-shaped duct 28 formed between the outer circumference of the inflow pipe 23 and a pipe piece 29 of relatively large diameter, which likewise projects into the inner drum upper part 17 from above.

At the bottom, a conical disk is attached to, in particular adhesively bonded to, or integrally formed on, the pipe piece 29, which conical disk is arranged in the manner of an upper separating disk 30 above the partition disk assembly, wherein the conical disk is spaced apart from the drum upper part such that a gap is formed between the drum upper part and the separating disk. Here, at the lower end, a flange-like circumferential edge 31 (see FIG. 1b) is placed between the flange regions 18 and 19 of the inner drum lower part 16 and of the inner drum upper part 17 and, there, it is preferably fixedly adhesively bonded to the flange regions, which stabilizes the arrangement of the separating disk 30 and also imparts additional strength to the entire structure.

A relatively heavy liquid phase (or a solids phase that is still just capable of being discharged, in particular is still just somewhat flowable) is conducted from the region of the largest inner circumference of the drum interior chamber through one or more bores 32 in the radially outer region of the separating disk into the gap 33, which functions as a duct, between the inner drum upper part 17 and the separating disk 30, specifically preferably as far as into a second ring-shaped gap 34—or into one or more ducts which are preferably spaced apart by ribs—between the pipe piece 29 surrounding the inflow pipe and an axial pipe neck 45 of the inner drum upper part 17.

The relatively heavy and the relatively light liquid phase flow out of the ring-shaped ducts 28, 34 upwardly in each case into ring-shaped chambers 35, 36, arranged axially one above the other, in a covering ring body 37 that is fastened non-rotatably (in a manner to be discussed in more detail below) to the housing 1. It is advantageous that, in this way, nozzles or the like which lead radially out of the drum for the purposes of discharging solids are omitted, such that there is no contact between the interior of the drum and the drum surroundings in the container.

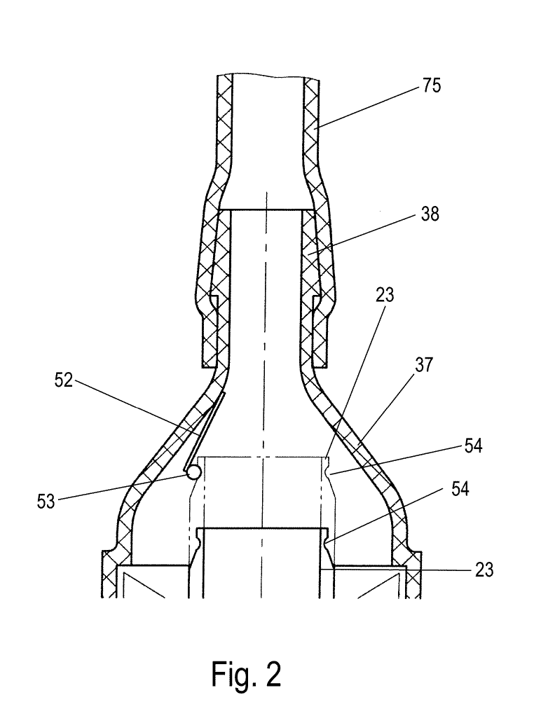

The covering ring body 37 is preferably of stepped form and has, in its vertically upmost region, an attachment connector 38 as an attachment means for an inflow line 75 (which can, however, be seen in FIG. 2 and will be discussed in more detail further below). Proceeding from the attachment connector 38, the covering ring body 37 widens in stepped fashion. The internally hollow attachment connector 38 opens into an axially uppermost ring-shaped chamber 39 on the inner circumference of the covering ring body 37, into which ring-shaped chamber of the upper end of the inflow pipe 23 extends axially from below, which inflow pipe rotates with the drum during the operation of the centrifuge and duly opens into the ring-shaped chamber 39 but is situated spaced apart from the covering ring body 37 at all locations in the ring-shaped chamber 39. In this way, the material for centrifuging that flows in and which is to be processed is transferred into the rotating system in a simple manner. Downwardly, each of the ring-shaped chambers 39, 35, 36 is delimited preferably in each case by a seal arrangement 40, 41, 42 on one or more (in this case two) sealing rings which are arranged between the outer circumference of the inflow pipe 23 and the inner wall of the ring-shaped chamber. As seal arrangements 40, 41, 42, it is preferable for in each case two sealing rings that are axially spaced apart from one another to be provided, in particular in the manner of slip ring seals.

Below the uppermost seal arrangement 40, the covering ring body 37 widens further at a next step. Here, between the inflow pipe 23 and the inner circumference of the covering ring body 37, below the uppermost seal arrangement 40 and above the middle seal arrangement 41, the middle ring-shaped chamber 36 is formed between the outer circumference of the inflow pipe 23 and the inner circumference of the covering ring body 37. The middle ring-shaped chamber serves for the discharge of the light liquid phase. For this purpose, a further attachment connector 43 may be formed on the covering ring body 37, which further attachment connector extends preferably radially or obliquely away from the rest of the covering ring body 37. The pipe end adjoining the separating disk 30 opens into the ring-shaped chamber 36 from below. The middle seal arrangement 41 is arranged between the outer circumference of the pipe piece 29 and the inner circumference of the covering ring body 37.

Below the middle seal arrangement 41, the covering ring body 37 widens yet further at a next step. Here, between the outer circumference of the pipe piece 29 and the inner circumference of the covering ring body 37, below the middle seal arrangement 41 and above the lower seal arrangement 42, the ring-shaped chamber 35 is formed between the outer circumference of the pipe piece 29 and the inner circumference of the covering ring body 37. The lower ring-shaped chamber 35 serves for the discharge of a relatively heavy liquid phase, in relation to the relatively light liquid phase, from the rotating system.

For this purpose, a further attachment connector 44 may be formed on the covering ring body 37, which further attachment connector extends (in this case obliquely) preferably radially away from the rest of the covering ring body 37. The lower seal arrangement 42 is arranged between the outer circumferences of the pipe neck 45 of the inner drum upper part 17 and the inner circumference of the covering ring body 37.

On the seal arrangements 40, 41, 42 there may be formed leakage chambers 80 from which leakage fluid can flow out of the rotating system through attachment connectors 81, wherein, in turn, lines and/or leakage containers are connected to the attachment connectors 81.

Below the seal arrangement 42, the ring body 37 widens yet further. The ring body is fixed by way of fastening means at its lower circumferential edge to an upper opening of the housing, which is extended through by the ring body and by the pipe neck 45 and by the elements that extend through the inside of the pipe neck. The fixing may be realized, for example, by way of circumferentially distributed screws 22, which are fixedly screwed to the housing 1 (preferably to the cover 5). For this purpose, the ring body 37 may have corresponding threaded screw receptacles 73.

In order for the inner drum and the outer drum 12, 11 to be easily connected to one another rotationally conjointly but detachably in a standstill state, it may be provided that the inner drum 12 is connected to the outer drum 11 in positively locking and/or non-positively locking fashion.

A non-positively locking connection may be realized in a simple manner by virtue of the flange regions 18 and 19 and the outer edge 31 of the separating disk 30 extending as far as into the screw-connection region between the outer drum lower part and the outer drum upper part, where they bear in each case against steps of the parts and are, during the screw connection of the drum upper part in the drum lower part, clamped between these with screw action (FIG. 1b).

It is additionally possible for positive-locking means such as ribs 87 (and/or grooves) to be provided on the outer circumference of the inner drum and for corresponding grooves 88 (and/or ribs) to be provided on the inner circumference of the outer drum 11, which ribs and grooves engage into one another and thereby connect the two elements, inner drum 12 and outer drum 11, rotationally conjointly (FIG. 1a).

It has proven to be particularly advantageous if one or more of the ribs 87 is formed on the outside (on the outer surface or on the outer shell of the outer drum), preferably in circumferentially distributed fashion, on the inner drum lower part 16, and correspondingly, one or more of the grooves 88 is formed on the outside (on the inner surface facing toward the inner drum), in circumferentially distributed fashion, on the outer drum lower part 13. The outer drum lower part 13 is in this case advantageously of doubly conical form and has an inner conical region 13a and an oppositely oriented outer conical region 13b. The inner drum lower part 16 has a corresponding doubly conical form with an inner conical region 16a and an outer conical region 16b. The one or more positive-locking means, in particular ribs 87, is/are preferably formed on the outside on the inner conical region 16a of the inner drum lower part 16 or project(s) therefrom, and the one or more corresponding positive-locking means, in particular grooves/recesses 88, is/are correspondingly formed on the inner conical region 13a of the inner drum upper part 13, on the inner surface thereof. Specifically the arrangement in a/the region close to the drive spindle 7 permits a highly effective transmission of torque, which ensures a very high level of running smoothness, from the outer drum to the inner drum. A transmission of torque into other regions on the outside on the inner and outer drum is, however, also conceivable.

During operation the inner drum 12 will bear, with radial expansion, against the inner circumference of the outer drum 11, which improves the transmission of torque and the rotary drive of the inner drum 12 by the driven outer drum 11. It would alternatively also be conceivable for the parts of the outer drum to be detachably connected to one another in some other way, for example by way of screw bolts or the like or by way of a bayonet.

In this way, a part, or preferably even all, of those regions of the rotating system coming into contact with the product, in particular the inner drum lower part 16 and the inner drum upper part 17, is or are composed of plastic or plastics composite material. It is furthermore preferably the case that the partition disk 26 is composed of plastic, and also all or almost all of those regions of the inflow system and of the outflow system coming into contact with the product, even if the regions do not rotate during operation. In this way, it is possible for the inner drum 12 to be disposed of after the processing of an adequately large product batch. The preferably metallic outer drum 11 is, by contrast, reused. Since the outer drum cannot come into contact with product during operation, the cleaning thereof is very straightforward or of less importance. Due to the outer drum 11, the inner drum 12 can be designed with very thin walls. In the case of complete disposal, correspondingly very little plastics waste is generated.

FIG. 1 shows an embodiment as a two-phase separating machine (separation of a product into the phases: “liquid/liquid”); three-phase machines (for separation into three phases) may likewise be realized (not illustrated here). The product is preferably, but not imperatively, a fermentation broth which is to be concentrated.

In this way, it is preferably the case that the entire inner drum together with the inflow and outflow system is preferably designed as an exchangeable, preassembled module composed of plastic or of a plastics composite material.

Here, the outer drum section 11 serves substantially as a holder for the inner drum 12, which in particular improves the running characteristics of the inner drum 12.

The design of the outer drum upper part as a ring will be optimized in tests. Here, it is possible to determine the conical region into which the ring-shaped outer drum cover or the outer drum upper part must, in an upward direction, surround the inner drum upper part.

Below, the construction of the housing 1 will be considered in more detail once again. The housing 1 has a base 3, a preferably cylindrical housing shell 4 and the cover 5. The housing comes into contact with the plastics region, which can be disposed of after operation, only in the region of the covering ring body 37.

The base 3 is in this case in the form of a separate base plate 46. It is preferable—but not imperative—for the base plate 46 to be of circular form. The housing shell 4 is arranged on the base. Here, an edge region of the base serves as a flange-like rest surface 47 for a lower flange section 48 of the housing shell 4, which in this case, in a preferred refinement, is cylindrical. The housing shell 4 furthermore has an upper flange section 49, to which the cover 5 is fixedly screwed.

The base plate 36 may be utilized for support on a counter-bearing (not illustrated here) such as a foundation or a machine frame. For this purpose, it is furthermore the case that bores 74 are formed in the flange section 48, at which bores the flange section can be fixed to the counter-bearing (for example by way of screws that are not illustrated here).

It is advantageous that the housing 1 has an outflow opening 59, preferably in its base 3, through which outflow opening it is possible, if necessary, for liquid, which collects in the housing for example due to an unpredicted leakage or for some other reason, to flow out. For this purpose, a discharge line such as an outflow hose may be arranged on a connector of the opening 59 for the purposes of discharging the liquid into a container.

A particularly compact structural form is realized in that—as already discussed in the introduction—the drive motor is preferably an electric motor arranged directly in an axial elongation of the drive spindle 7, preferably at the side averted from the drum. The drive spindle 7 is preferably connected directly axially to the drive output shaft 10 by way of a bolt. The drive spindle is furthermore connected rotationally conjointly (not illustrated here) in a circumferential direction to the drive output shaft of the electric motor by way of a torque transmission means, preferably a feather key. The torque transmission means may also be of some other form, for example in the form of a torque transmission contour (in each case not illustrated here). A terminal box 75 is arranged on the motor 8.

The rotatable drum 2 may be connected to the drive spindle structure by way of an interference fit (for example in a conical section), or by way of some other torque transmission means (not illustrated here). Here, the motor 8, at its side facing toward the spindle 7, is furthermore fastened, for example screwed by way of screw bolts, by way of a flange section 50 to the base of the housing 1. A terminal box 51 is also arranged on the motor 8.

Advantageous possibilities for a transport lock of the rotating system composed of plastic will be described in more detail below. As discussed above, it is possible for the rotating system composed of plastic to be exchanged from time to time. For this purpose, the invention also provides a device for at least axially securing the covering ring body 37 to an element of the rotating system of the separator of the inner drum in any case in the transport state, that is to say in the state not mounted in the outer drum and in the housing 1.

Since the ring body, as a part which does not rotate during operation, is connected merely by way of the seal arrangements 40, 41, 42 to the parts that rotate during operation and with which the ring body forms ring-shaped chambers, there would, without a means for an at least axial transport lock, be the risk of the covering ring body 37 becoming axially detached. By contrast, during operation, the risk does not exist because the inner drum 12 is supported via the outer drum lower part on the motor and via the latter on the housing 1, and the covering ring body 37 is supported directly on the housing 1, and these are consequently adequately fixed in position relative to one another.

FIG. 2 illustrates an upper section of the covering ring body 37 with the attachment connector 38 as an attachment means for a hose-like inflow line 75, and an upper section of the inflow pipe and of the upper seal arrangement 40. The hose-like inflow line 75 (and analogously hose-like outflow lines at the further attachment connectors 43, 44) is/are preferably fastened to the attachment connector by adhesive action for preassembly purposes. The hoses may be adhesively bonded closed at the ends averted from the attachment connectors. Before commencement of operation, the adhesively bonded ends are cut off and are welded to a hose piece originating for example from the fermenter. Other variants for the connection of the hoses and connectors and for closing off line ends that may be open are also conceivable. For example, for connection purposes, coupling elements are conceivable that are designed, for example, with detent action, or closure of the ends by way of cable ties or similar elements is conceivable.

FIGS. 2 to 4 furthermore show the inflow pipe 23 in a state in which it has been pushed axially further (in this case upwardly in the direction of the upper attachment connector 38) into the body 37 (dashed line) and in a state in which it has been moved somewhat further axially downward (solid line). The state indicated by dashed lines, or the state, in which the inflow pipe 23 has been pushed in further, indicates the state for transport, and the state indicated by non-dashed lines indicates the installed state in the outer drum 11 for operation.

FIGS. 2 to 4 show variants of the device for at least axially securing the covering ring body to an element of the rotating system of the separator of the inner drum in any case in the transport state, that is to say in the state not mounted in the outer drum 11 and in the housing 1.

Here, the axial transport lock is based on non-positive locking and/or positive locking.

In the case of FIG. 2, combined non-positive and positive locking is realized. Here, a projection 53, for example a pin, arranged on a leaf spring 52 engages into a ring-shaped groove 54 on the outer circumference of the inflow pipe 23 in the state in which the inflow pipe has been pushed further into the covering ring body 37. The force of the spring is selected such that a good transport lock is realized, but such that it is nevertheless possible, after the transportation and during the assembly process, for the transport lock to be released by way of a targeted axial movement of the inflow pipe downward.

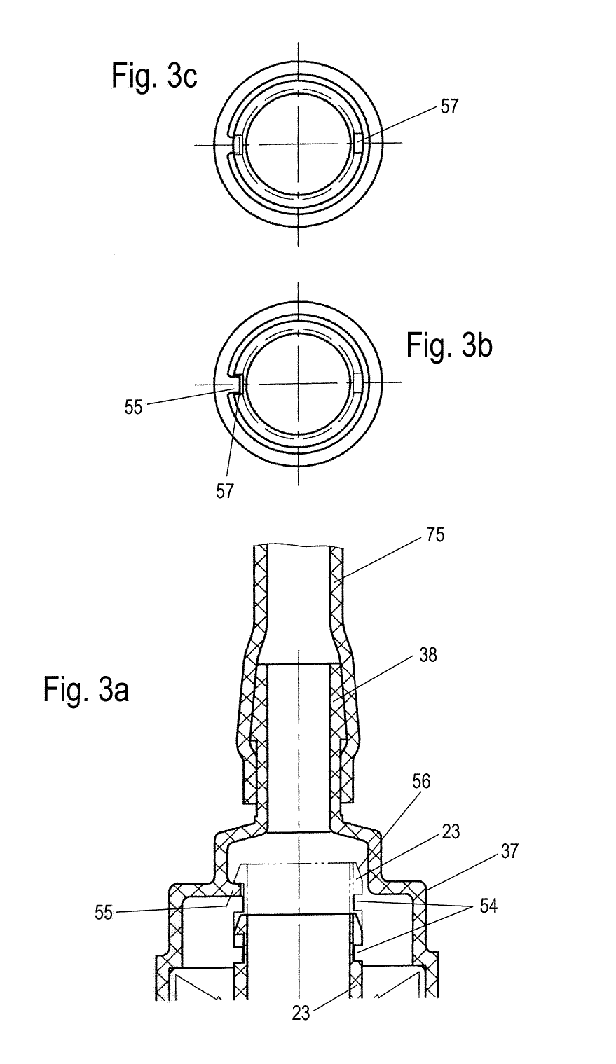

In the case of FIGS. 3a-3c, such positive locking in a ring-shaped groove 54 of the inflow pipe 23 is realized by virtue of a radially inwardly projecting web 55 on the covering ring body 37 engaging at the inside into the ring-shaped groove 54 of the inflow pipe 23. By way of a narrowing/bevel 56 on the free upper end of the inflow pipe 23, it is possible for the inflow pipe to be pushed into the transport lock position, in particular before the disposal of the rotating system or before initial transport.

For attachment, the covering ring body 37 must be rotated such that the web 55 is aligned with a radial groove 57 above the ring-shaped groove 54. In this position the discharge pipe can be pulled into its operating position illustrated by non-dashed lines (see FIGS. 3b, 3c).

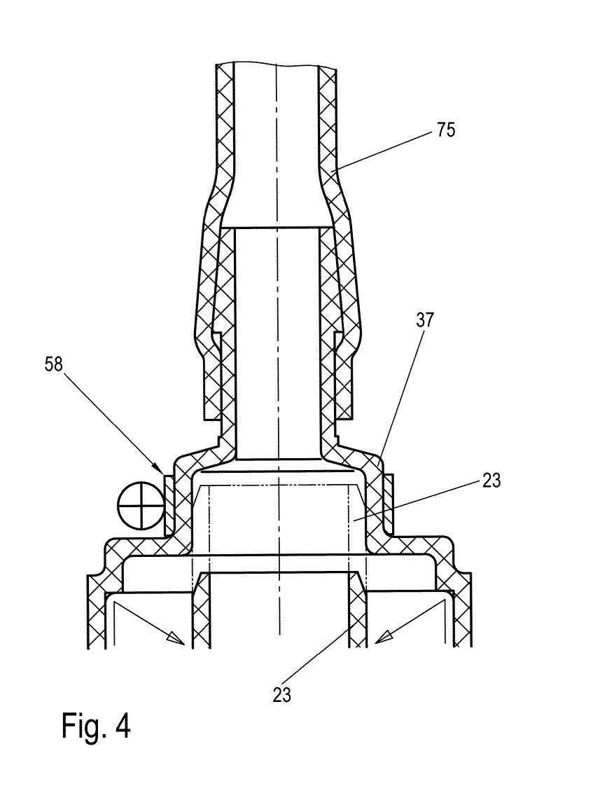

In the case of FIG. 4, releasable non-positive locking is realized by virtue of a type of clamping ring 58 (similarly to a tightenable hose clip) being placed around the outside of the covering ring body 37 and being tightened so as to press the covering ring body 37 in non-positively locking fashion against the outer circumference of the inflow pipe 23.

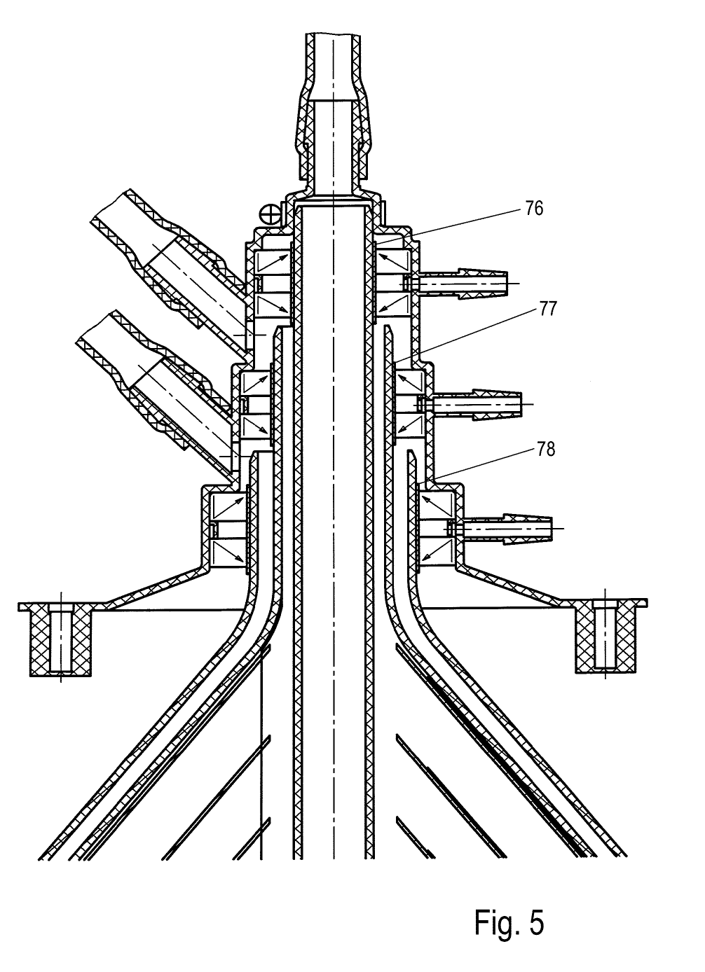

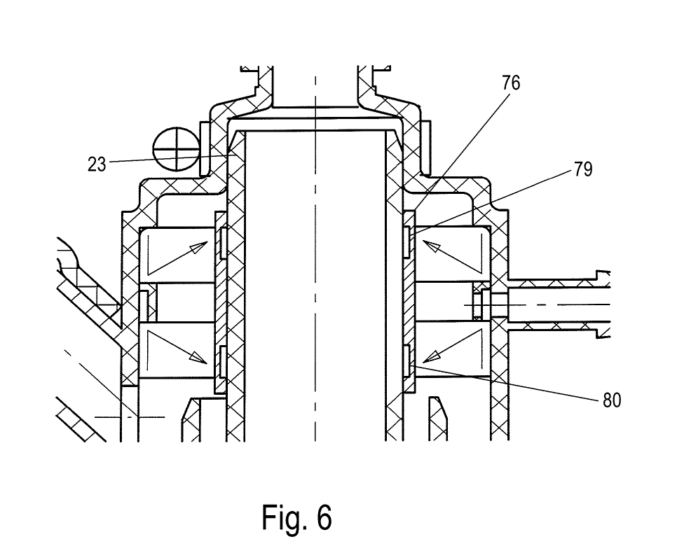

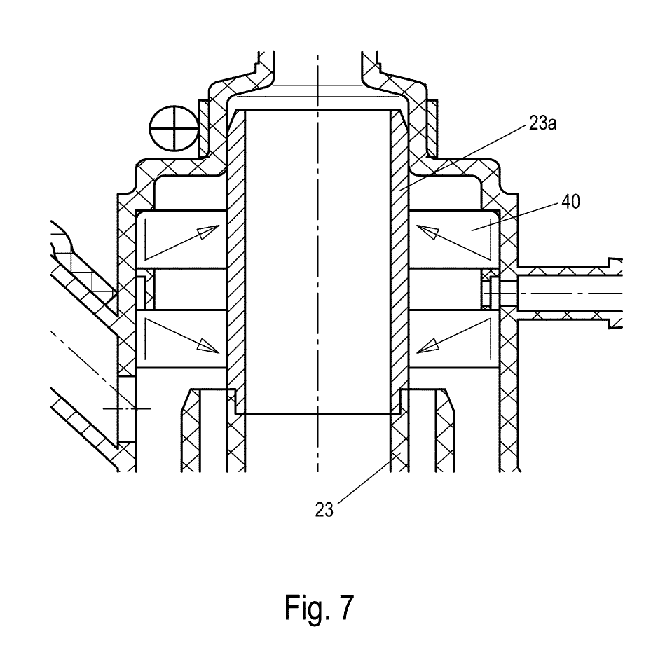

FIGS. 5 and 6 illustrate that it is also possible for reinforcement elements to be provided locally within the drum composed of plastic, in particular the inner drum. Here, the reinforcement elements are in the form of sleeves 76, 77, 78. The sleeves are situated, with protective action, radially between in each case one of the seal arrangements 40, 41, 42 and the associated inner pipe/pipe piece/pipe neck 23, 29, 45, and reinforce these. Alternatively, it is possible for one or more of the sleeves to itself form a partial section of a pipe/pipe piece/pipe neck 23, 29, 45. Such a refinement as shown in FIG. 7. Here, a sleeve 23a forms an axial end of the inflow pipe 23. The seal arrangement 40 is arranged radially at the outside with respect to the sleeve 23a.

For this purpose, the sleeves 23a, 76, 77, 78 may, depending on requirements, be designed with insulating or heat-conducting properties. The sleeves are preferably likewise composed of plastic (preferably of a high-temperature-resistant and preferably high-strength plastic). It is however also conceivable and preferable for the sleeves to be manufactured in some other way, for example from other plastics, plastics composite materials, or other composite materials. Reinforcement elements composed in particular of glass, metal or plastic-metal combinations (for example plastic with metal mesh for the purposes of dissipating the heat) are conceivable. These are separated if necessary for recycling or disposal.

It is particularly advantageous that the sleeves 23a, 76, 77, 78, due to the material selection, warm up to a lesser extent than the rest of the pipe/pipe piece/pipe neck 23, 29, 45. This is the case in particular if the sleeve 23a, 76, 77, 78 is composed of metal. Here, it is in turn particularly advantageous if the sleeve, practically on its own, forms a pipe section of the pipe/pipe piece/pipe neck 23, 29, 45.

If the sleeve—for example 23a—itself forms a partial section, in particular an end, of a pipe, it is expedient for the partial section to be preferably inseparably fixedly connected to the rest of the pipe/pipe piece/pipe neck 23, 29, 45. In the latter case, it is expedient for the sleeve to be adhesively bonded to the rest of the pipe/pipe piece/pipe neck 23, 29, 45, or for the sleeve to be placed into the corresponding mold during the injection molding of the plastics pipe, such that an intimate connection is realized in particular between metal and plastic. The sleeve 23a, 76, 77, 78 and the pipe/pipe piece/pipe neck 23, 29, 45 may also overlap, or engage into one another, in sections (FIG. 7).

In the case of the sleeve being composed of metal, the sleeve has a relatively large heat absorption capacity, such that it does not warm up to too high a temperature in particular as the drum runs up to operating rotational speed. This in turn protects temperature-sensitive elements, in particular the slip ring seals which are arranged in the region of the sleeve and which preferably adjoin the sleeve.

In the case of FIG. 6, one or more of the sleeves 76, 77, 78—in this case at the inner circumferential edge—has or have one or more grooves, in particular ring-shaped grooves 79, or one or more chambers, which, by forming air chambers, contribute(s) to a reduction of the heat conduction and thus protect(s) the adjoining elements, in particular seals.

Although the present invention has been described above by means of embodiments with reference to the enclosed drawings, it is understood that various changes and developments can be implemented without leaving the scope of the present invention, as it is defined in the enclosed claims.

### LIST OF REFERENCE DESIGNATIONS

Housing 1
Drum 2
Base 3
Housing shell 4
Cover 5
Leadthrough 6
Drive spindle 7
Drive motor 8
Gap 9
Drive shaft 10
Outer drum 11
Inner drum 12
Outer drum lower part 13
Conical regions 13a, b
Outer drum upper part 14
Centrifuging chamber 15
Inner drum lower part 16
Conical regions 16a, b
Inner drum upper part 17
Flange regions 18, 19
Section 20
Distributor neck 21
Screws 22
Inflow pipe 23
Distributor ducts 24
Disk assembly 25
Partition disk 26
Duct 27
Ring-shaped duct 28
Pipe piece 29
Separating disk 30
Circumferential edge 31
Bores 32
Gap 33
Ring-shaped duct 34
Ring-shaped chambers 35, 36
Covering ring body 37
Attachment connector 38
Ring-shaped chamber 39
Seal arrangement 40, 41, 42
Attachment connector 43
Attachment connector 44
Pipe neck 45
Base plate 46
Rest surface 47
Flange section 48
Bores 49
Flange section 50
Terminal box 51
Leaf spring 52
Projection 53
Ring-shaped groove 54
Web 55
Narrowing/bevel 56
Radial groove 57
Clamping ring 58
Outflow opening 59
Detent means 60
Webs 61
Detent contour 62
Detent means 63
Sealing ring 64
Thread 71
Seal 72
Screw receptacles 73
Bores 74
Inflow line 75
Sleeves 76, 77, 78
Ring-shaped grooves 79
Leakage chambers 80
Leakage connector 81
Channels 82, 83
Ring-shaped chamber 84
Closure ring 85
Thread 86
Ribs 87
Grooves 88
Vertical axis of rotation D

1-86. (canceled)

87. A separator for the processing of a flowable product by centrifugation, the separator comprising:
a centrifuging chamber;
a rotatable drum delimiting the centrifuging chamber, wherein the rotatable drum has an outer support device and an inner drum inserted into and arranged in the outer support device; and
a means for clarifying the flowable product in the centrifugal chamber arranged in the inner drum.

88. The separator of claim 87, wherein the outer support device is at least one outer ring axially surrounding the inner drum in sections.

89. The separator of claim 87, wherein the outer support device is a circumferentially closed outer ring axially surrounding the inner drum axially.

90. The separator of claim 87, wherein the outer support device is a grate-like outer ring axially surrounding the inner drum in sections.

91. The separator of claim 87, wherein the outer support device is an outer drum in which the inner drum is arranged.

92. The separator of claim 91, wherein the outer drum is configured as a holder into which the inner drum is inserted.

93. The separator of claim 91, wherein the outer drum axially surrounds the inner drum only in sections.

94. The separator of claim 91, wherein the outer drum is circumferentially closed where the outer drum surrounds the inner drum.

95. The separator of claim 87, wherein an entirety of the inner drum, together with an inflow and outflow system, is configured as an exchangeable, preassembled module.

96. The separator of claim 91, wherein the outer drum fully surrounds the inner drum in a circumferential direction.

97. The separator of claim 91, wherein the outer drum axially surrounds the inner drum completely.

98. The separator of claim 91, wherein the outer drum axially surrounds the inner drum only in sections.

99. The separator of claim 91, wherein the inner drum protrudes axially out of the outer drum.

100. The separator of claim 91, wherein the inner drum and the outer drum are composed of different materials.

101. The separator of claim 100, wherein the inner drum is composed of plastic or of a plastics composite material.

102. The separator of claim 100, wherein the outer drum is composed of steel.

103. The separator of claim 91, wherein the outer drum has an outer drum lower part and an outer drum upper part.

104. The separator of claim 103, wherein the outer drum lower part and the outer drum upper part are fixed to one another by screw means.

105. The separator of claim 104, wherein the screw means comprise:
a. screw bolts;
b. a fastener ring; or
c. a thread between the outer drum upper part and the outer drum lower part.

106. The separator of claim 103, wherein the inner drum has an inner drum lower part and an inner drum upper part.

107. The separator of claim 106, wherein the inner drum lower part and the inner drum upper part are connected to one another in non-disassemblable fashion.

108. The separator of claim 106, wherein the inner drum lower part and the inner drum upper part are adhesively bonded or welded to one another.

109. The separator of claim 106, wherein the inner drum lower part and the inner drum upper part are mechanically connected to one another.

110. The separator of claim 106, wherein an encircling sealing ring is arranged or formed between the inner drum lower part and the inner drum upper part.

111. The separator of claim 106, wherein the outer drum upper part is formed as a ring and is open in an axially upward direction, such that the inner drum upper part protrudes axially out of said outer drum upper part.

112. The separator of claim 106, wherein one or both of the following parts is or are conical:
the outer drum upper part;
the inner drum upper part;
the outer drum lower part; and
the inner drum lower part.

113. The separator of claim 106, wherein the outer drum lower part has a doubly conical shape and has an inner conical region and an outer conical region, the inner drum lower part has a doubly conical shape corresponding to the doubly conical shape of the outer drum lower part, and the doubly conical shape of the inner drum lower part has an inner conical region and an outer conical region.

114. The separator of claim 113, wherein the inner drum and the outer drum are connected rotationally conjointly to one another in non-positively locking or positively locking fashion.

115. The separator of claim 113, wherein the inner drum and the outer drum are connected rotationally conjointly to one another by way of at least one or more corresponding positive-locking means.

116. The separator of claim 115, wherein the inner drum has, as the positive-locking means, at least one or more ribs which engage(s) into one or more corresponding grooves on the outer drum lower part.

117. The separator of claim 116, wherein the one or more ribs are formed on the inner conical region of the inner drum lower part on the outer surface thereof, and the one or more grooves is or are formed correspondingly on the inner conical region of the inner drum upper part on the inner surface thereof.

118. The separator of claim 87, wherein the outer drum is driven by a drive motor.

119. The separator of claim 87, wherein the means for clarifying is a disk assembly composed of a stack of partition disks manufactured from plastic or from a plastics composite material.

120. The separator of claim 113, wherein the outer drum upper part extends as far as into the conical section of the inner drum upper part in such a way that the inner drum upper part still protrudes, by way of a part of its conical region, vertically upwardly out of the outer drum upper part.

121. The separator of claim 91, wherein the outer drum lower part is connected rotationally conjointly to a drive spindle.

122. The separator of claim 87, further comprising:
an inflow system and a outflow system of the drum, wherein the inflow and outflow system are formed exclusively on the inner drum.

123. The separator of claim 122, wherein a wall of the inner drum contains no solids discharge openings leading radially out of the inner drum into the space surrounding the inner drum.

124. The separator of claim 122, wherein the inflow system and the outflow system are formed, in a sealed-type of construction, on the inner drum.

125. The separator of claim 122, wherein the inflow system and the outflow system have a covering ring body which does not rotate with the rotatable drum during operation.

126. The separator of claim 125, wherein the inflow system has an inflow pipe that rotates with the drum.

127. The separator of claim 126, wherein the inflow pipe projects into the covering ring body.

128. The separator of claim 126, wherein one or more further pipe elements, which rotate with the drum during operation, project into the ring body.

129. The separator of claim 125, further comprising:
one or more seal arrangements each with one or more sealing rings are arranged between the covering ring body and rotating pipe elements or ends of the rotatable drum.

130. The separator of claim 126, wherein the inflow pipe is guided in axially displaceable fashion in the covering ring body, and a device for the detachable fixing of the at least one pipe element in an axial position in the covering ring body is provided.

131. The separator of claim 130, wherein the device for the detachable fixing of the pipe element in an axial position in the covering ring body achieves a detachable positive locking and/or non-positive locking action.

132. The separator of claim 106, wherein the inner drum lower part includes a distributor neck having distributed ducts configured to conduct the flowable product from an inflow pipe into the centrifuging chamber or an interior chamber of the rotatable drum.

133. The separator of claim 87, wherein all regions of the rotatable drum coming into contact with the flowable product during operation are composed of plastic or of a plastics composite material.

134. The separator of claim 122, wherein an entirety of the inner drum together with the inflow and outflow system are configured as an exchangeable, preassembled module composed of plastic or of a plastics composite material.

135. The separator of claim 87, wherein the rotatable drum is arranged in a housing.

136. The separator of claim 106, wherein at least one outflow duct for a heavy product phase is integrated into the inner drum upper part.

137. The separator of claim 125, wherein outflow regions of the outflow system are ring-shaped ducts which are open axially into ring-shaped chambers of the covering ring body.

138. The separator of claim 87, wherein one or more reinforcement elements is or are provided for a pipe, a pipe piece, or a pipe neck composed of plastic or plastics composite material, wherein the one or more reinforcement elements is or are in the form of sleeve(s).

139. The separator of claim 138, wherein an inside of the inner drum includes one or more metal reinforcement elements.

140. The separator of claim 138, wherein the sleeve is composed of ceramic or metal.
